(19) United States
(12) Patent Application Publication
(10) Pub. No.: US 2015/0059089 A1
(43) Pub. Date: Mar. 5, 2015

(54) Portable Cot Apparatus for Hands and Legs Free Inflight Sleeping

(71) Applicant: Matthew Falkiner, Cardiff by the Sea, CA (US)

(72) Inventor: Matthew Falkiner, Cardiff by the Sea, CA (US)

(21) Appl. No.: 14/471,622

(22) Filed: Aug. 28, 2014

Related U.S. Application Data
(60) Provisional application No. 61/871,060, filed on Aug. 28, 2013.

(51) Int. Cl. B64D 11/00; B60N 3/00; B64D 11/06; A47D 7/00

(52) U.S. Cl. CPC B64D 11/00; A47D 7/002; B60N 3/008; B64D 11/06; B64D 2011/0069
USPC 5/110

(57) ABSTRACT

A foldable and portable cot apparatus for assisting inflight sleeping is disclosed. The cot apparatus may include a frame structure, a flexible platform and two supporting legs. In an assembled and in-use orientation, the frame may be supported by the legs, allowing the positioning of the frame structure and platform over the arms of an airplane seat. A baby can be laid down over the platform enclosed by the frame for resting or sleeping. Supporting legs and side rails can be detached from the frame structure in order to fold and roll up the cot apparatus into a fully-folded orientation for carry and/or storage. The length of supporting legs may be adjusted using suitable telescopic mechanisms for fitting airplane seats of different dimensions. The cot apparatus may be also configured in a unibody structure with no detachable components or parts, where side rails may include a folding mechanism that may allow to fold or unfold the cot apparatus as required.

### CROSS-REFERENCE TO RELATED APPLICATION

This application claims priority to U.S. Provisional Patent Application Ser. No. 61/871,060, filed Aug. 28, 2013, entitled “Portable Cot Apparatus for Hands and Legs Free Inflight Sleeping,” which is incorporated herein by reference as if set forth in its entirety.

### BACKGROUND

1. Field of the Disclosure

The present disclosure relates in general to cots, and more specifically to portable and foldable cots that can be used for inflight sleeping.

2. Background Information

For families traveling with babies, long domestic or international flights may be somewhat uncomfortable. In particular, parents traveling with a baby may have a difficult time or may struggle when trying to get some sleep for themselves and for the baby. Generally, during long flights, families may have the options of holding the baby in their laps or buy an additional seat. In the first scenario, holding the baby during long periods of time may be challenging and may require the constant use of the parent's hands and legs, thereby interfering with sleep. The latter scenario may require the use of a special infant seat that may be difficult to carry during the trip and may not appropriately fit some airplane seats.

Feasible solutions for this problem may be limited. Certain airplane models may include a foldable basket or table where the baby can be changed or can sleep, but this feature may be limited to certain airplane models and only 2 or 3 seats of this type may be available. Conventional portable cots, in the other hand, may not exhibit suitable dimensions for fitting airplanes seats, and they may be too big or heavy to carry and difficult to assemble.

What is needed is a portable and foldable cot apparatus that may provide assistance for inflight sleeping, while suitably fitting the dimensions and form of airplane seats. What is also needed is a portable and foldable cot apparatus that is easy to carry in a fully-folded orientation, and that can be assembled and disassembled without the use of tools.

### SUMMARY

A portable and foldable cot apparatus that provides assistance for inflight sleeping is disclosed. According to an embodiment, this cot apparatus may include a frame structure, a platform, and two legs. The frame structure may include a plurality of connectors and rails for enclosing the platform, while providing suitable tension to the platform. The legs may sit on the cabin floor and may support the frame structure, which can be subsequently positioned over the arms of an airplane seat. At this assembled and in-use orientation, the platform enclosed by the frame structure may function as a resting area where a baby can be laid down for conformable rest or sleep. The structural design of support legs, frame, and platform may be configured to suitably support the weight and height of the baby.

The frame structure may include front and back rails, two side rails, corner connectors, coupling connectors and tee connectors, where tee connectors may be coupled to the front rail through the coupling connectors and may also receive the support legs. Suitable materials for frame structure components and support legs may include plastic and aluminum, while the platform may include flexible materials such canvas, nylon, and the like.

According to embodiments described herein, the cot apparatus can be collapsed to a pre-folded orientation by detaching the side rails and support legs from the corner connectors and tee connectors respectively. The detached side rails and support legs can be placed within the flexible platform which can be subsequently folded and rolled-up to configure the cot apparatus in a fully-folded orientation. Cot apparatus in fully-folded orientation may be easily carried as a bag or carry-on luggage that may suitability fit in the airplane's storage compartments.

In other embodiments, the length of support legs in cot apparatus may be adjusted according to the distance between the arms of the airplane seat and the cabin floor, allowing cot apparatus to fit airplane seats of different dimensions. Specifically, one or more telescopic mechanisms may be used for adjusting the length of support legs. Yet in another embodiment, support legs may be permanently attached to tee connectors of the frame structure and may be folded up or down within a 90 degree range as required.

In a further embodiment, the cot apparatus may be configured using a unibody structure with no detachable components. Components of the frame, as well as the legs and platform may be assembled in a unibody structure, where side rails may include a folding mechanism for allowing the cot apparatus to be collapsed into a fully-folded orientation. This folding mechanism in the side rails of the frame may include a button that may be pressed for folding or unfolding the cot apparatus into a fully-folded orientation or in-use orientation respectively.

The disclosed cot apparatus may be configured in a fully-folded orientation for easy carry and storage. Parents traveling with babies may operate the cot apparatus with minimal or no use of their hands and legs, and without additional straps or hooking mechanisms for adapting cot apparatus to an airplane seat. In addition, the flexible and portable cot apparatus may be folded or assembled without the use of tools or additional hardware. Numerous other aspects, features and benefits of the present disclosure may be made apparent from the following detailed description taken together with the drawing figures.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 illustrates an exploded isometric view of a portable and foldable cot apparatus.

FIG. 2 shows an isometric view of portable and foldable cot apparatus in assembled and in-use orientation.

FIG. 3 depicts an isometric view of an application where a portable and foldable cot apparatus in assembled and in-use orientation may be used for assisting a baby's sleep during an airplane flight.

FIG. 4 illustrates a side view of an application where a portable and foldable cot apparatus in assembled and in-use orientation may be used for assisting a baby's sleep during an airplane flight.

FIG. 5 shows an isometric view of a portable and foldable cot apparatus in a pre-folded orientation.

FIG. 6 depicts an isometric view of a portable and foldable apparatus collapsed to a fully-folded orientation.

FIGS. 7A-C illustrates different configurations for adjusting the functionality and length of support legs.

FIG. 8 depicts an isometric view of a unibody configuration of a portable and foldable cot apparatus in an assembled and in-use orientation.

FIG. 9 shows an isometric view of a unibody configuration of a portable and foldable cot apparatus in a pre-folded orientation.

FIG. 10 illustrates an isometric view of a unibody configuration of a portable and foldable cot apparatus in a fully-folded orientation.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

### Definitions

As used here, the following terms may have the following definitions:

“Frame” refers to a component or part of a cot apparatus, where this frame may be include a plurality of connectors and rails, and may provide tension and structural support to a platform.

“Platform” refers to a component or part of a cot apparatus, where this platform may be enclosed by a frame structure, may be flexible and can be used as a resting or sleeping area for a baby.

“Legs” refer to detachable or foldable component of a cot apparatus, where these legs may provide support to a frame and a platform for positioning them over the arms of an airplane seat.

### Description of the Drawings

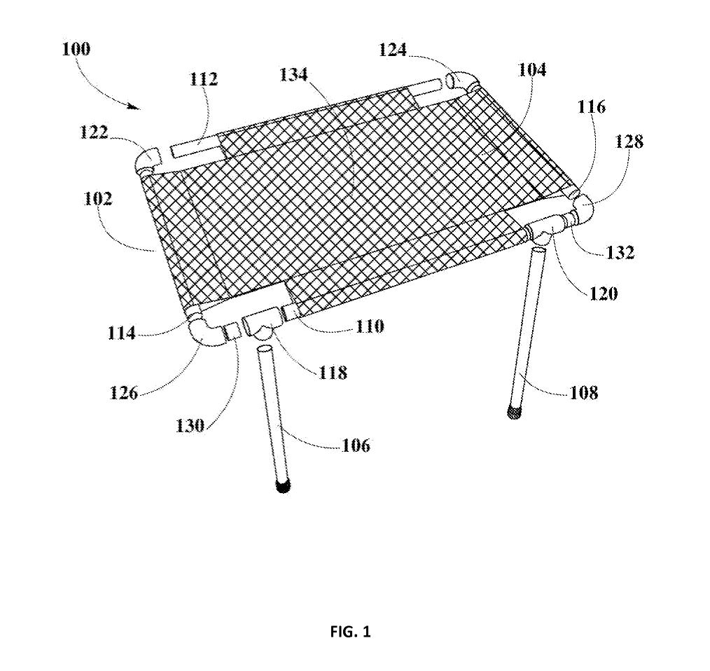

FIG. 1 shows an exploded isometric view of a portable and foldable cot apparatus 100, according to an embodiment. This portable and foldable cot apparatus 100 may include a frame 102, a platform 104, and two supporting legs 106 and 108.

According to an embodiment, frame 102 may include a front rail 110; a back rail 112; side rails 114 and 116; tee connectors 118 and 120; corner connectors 122, 124, 126 and 128; and coupling connectors 130 and 132. Corner connectors 122, 124, 126 and 128 may be configured at 90 degrees, where corner connectors 122 and 124 may accept back rail 112 and side rails 114, 116; while corner connectors 126 and 128 may accept side rails 114, 116 and coupling connectors 130, 132. These coupling connectors 130 and 132 may be configured to link corner connectors 126 and 128 with tee connectors 118 and 120 respectively. Front rail 110 may be operatively coupled with tee connectors 118 and 120.

Support legs 106, 108 may be operatively coupled with tee connectors 118 and 120 to raise frame 102 structure to a predetermined height above ground or cabin floor. According to some embodiments described herein, this predetermined height can be adjusted by varying the length of support legs 106, 108.

Frame 102 may be configured to enclose and hold platform 104, while also providing suitable tension to platform 104. Specifically, portions of platform 104 can be slid through side rails 114, 116, front rail 110, and back rail 112 as shown in FIG. 1. Suitable flexible and resistant materials that can be used in platform 104 may include canvas, fabric, nylon, and the like. According to an embodiment, this platform 104 may be detachable so it can be washed as necessary, in which case, platform 104 may include Velcro straps for easy attachment to frame 102 structure. Furthermore, platform 104 may include a padding or soft cushion within its resting region 134.

Frame 102 structure components and support legs 106,108 may be configured to securely assemble without the use of any tools or the need for additional hardware such as clamps, screws, bolts, brackets, and the like. Suitable materials for frame 102 structure components and support legs 106,108 may include plastic and aluminum.

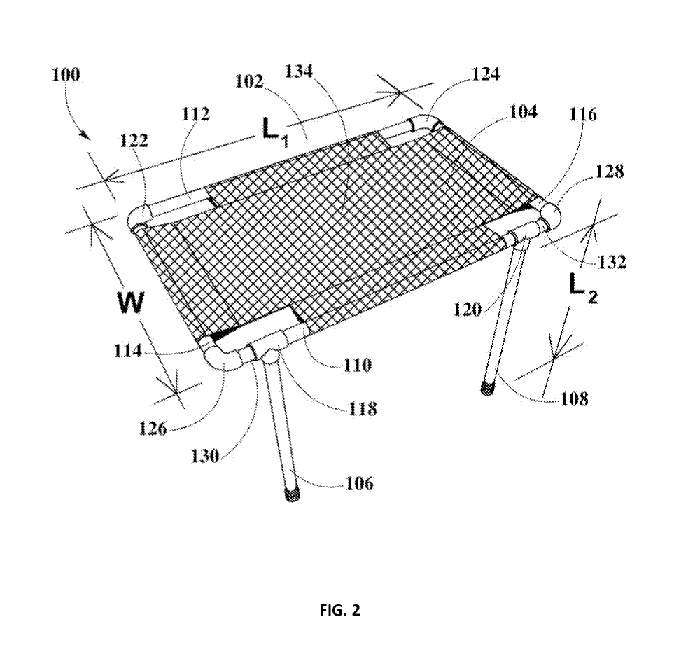

FIG. 2 depicts an isometric view of the portable and foldable cot apparatus 100 in assembled and in-use orientation, according to an embodiment. As seen in FIG. 2, legs 106 and 108 may support frame 102 structure, allowing the positioning of platform 104 as required by the application. For example, frame 102 structure and platform 104 may be positioned over the arms of an airplane seat in order to assist a baby's sleep. In an embodiment, side rails 114, 116 and legs 106, 108 may be detached from frame 102 structure for allowing cot apparatus 100 to be folded, rolled up and carried away as required.

The portable and foldable cot apparatus 100 may exhibit suitable dimensions for fitting an airplane seat. Specifically, width W of frame 102 may range from about 40 cm to about 50 cm, while length L₁ of frame 102 may vary from about 53 cm to about 75 cm. Similarly, length L₂ of legs 106, 108 may vary from about 50 cm to about 65 cm. The overall dimensions and structural strength of cot apparatus 100 may be suitable for carrying a baby of a height of about 50 cm to about 85 cm, and a weight ranging from about 7 lbs to about 26 lbs.

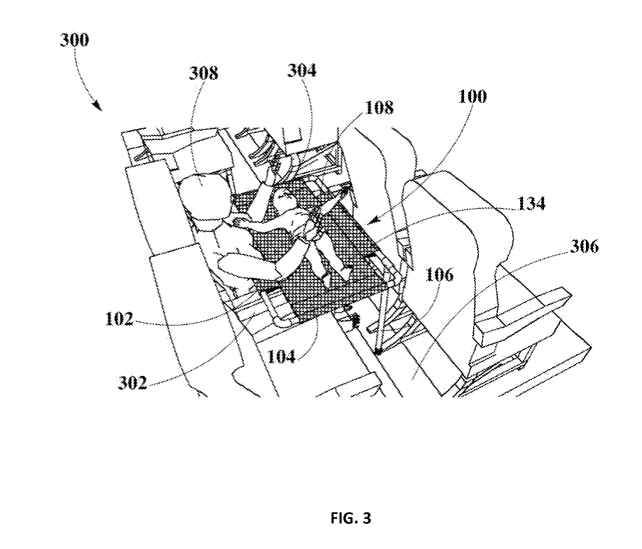

FIG. 3 shows an isometric view of application 300 where portable and foldable cot apparatus 100 in assembled and in-use orientation may be employed for assisting a baby's sleep during an airplane flight, according to an embodiment. As shown in FIG. 3, legs 106 and 108 can support frame 102 structure which can be positioned over the arms 302 of airplane seat without the need of additional clipping or fastening components. During use, a baby 304 can lay down over the resting region 134 of platform 104, with legs 106, 108 securely sitting on the cabin floor 306 to support the baby's weight distribution over platform 104. As depicted in FIG. 3, a parent 308 may be seated in front of frame 102 structure with minimal or no use of his/her hands to hold the baby 304 in the resting region 134 of platform 104.

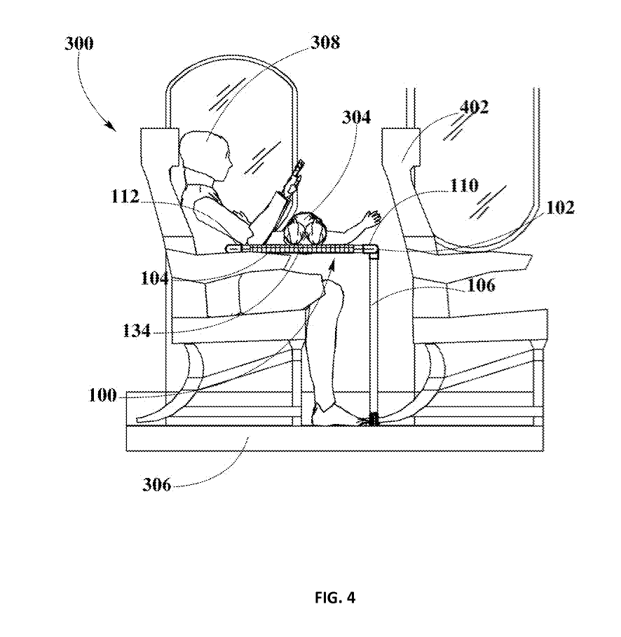

FIG. 4 shows a side view of application 300 where portable and foldable cot apparatus 100 in assembled and in-use orientation may be used for assisting a baby's sleep during an airplane flight, according to an embodiment. In this side view, it is easily appreciated how frame 102 structure can be suitably positioned over the airplane seat arms 302, preventing contact between the legs of parent 308 and platform 104, and increasing the overall comfort of both parent 308 and the baby 304 who may be sleeping on the resting region 134 of platform 104. In particular, parent 308 may be able to operate cot apparatus 100 with minimal or no use of his/her hands and legs, freeing them for other uses such as reading a magazine or just for relaxation and/or sleeping.

Support legs 106 and 108 can sit on the cabin floor 306 to provide suitable stability and weight support as required by application 300. Back rail 112 may be facing the parent 308 torso, in contact or within some spacing from about 5 cm to about 10 cm; while front rail 110 may be facing the back of front seat 402, in contact or within some spacing from about 2 cm to about 10 cm.

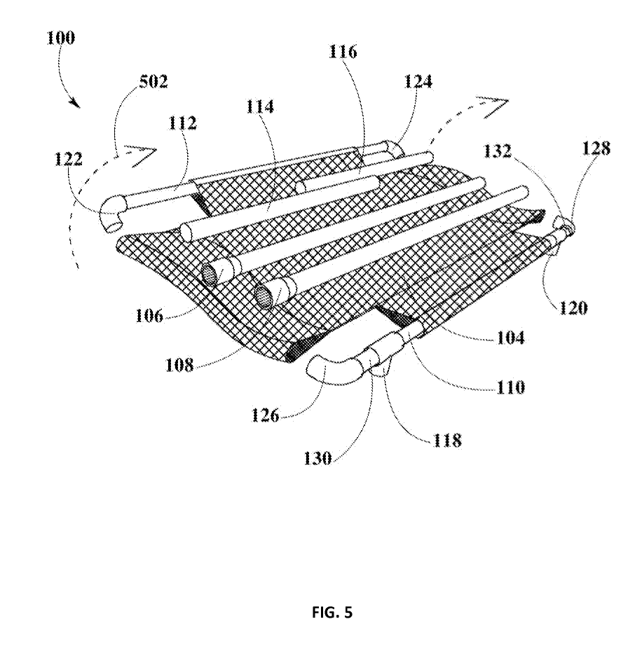

FIG. 5 shows an isometric view of the portable and foldable cot apparatus 100 in a pre-folded orientation, according to an embodiment. After using cot apparatus 100 in application 300, side rails 114 and 116 can be detached from corner connectors 122, 124, 126 and 128 of frame 102 structure in order to allow cot apparatus 100 to be folded. Similarly, legs 106 and 108 can be detached from tee connectors 118 and 120 of frame 102 structure. When detached, side rails 114, 116 and legs 106, 108 can be placed within the flexible and foldable platform 104, and subsequently, cot apparatus 100 can be collapsed and rolled-up using a folding action 502 as shown in FIG. 5.

Side rails 114, 116 and legs 106, 108 can be detached or attached to frame 102 structure as required by application 300 and without the use of tools, simplifying the use and applicability of cot apparatus 100.

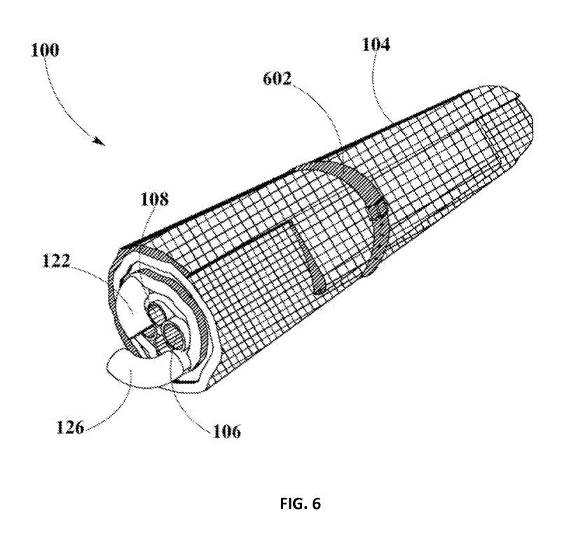

Referring now to FIG. 6, cot apparatus 100 can be collapsed to a fully-folded orientation for easy transportation and storage, according to an embodiment. Following the folding action 502 described in FIG. 5, cot apparatus 100 can be completely rolled-up to a fully-folded orientation which may take the form of a cylindrical bag as depicted in FIG. 6, where platform 104 may specifically function as a cover to enclose and protect frame 102 components and support legs 106, 108. Cot apparatus 100 may be securely kept in fully-folded orientation using a suitable tie 602 which may include a belt, a cord, and the like. In an embodiment, flexible platform 104 may include Velcro straps for holding cot apparatus 100 in full-folded orientation.

Cot apparatus 100 in fully-folded orientation may be carried as a bag or carry-on luggage that may easily fit airplane's storage compartments and comply with security requirements.

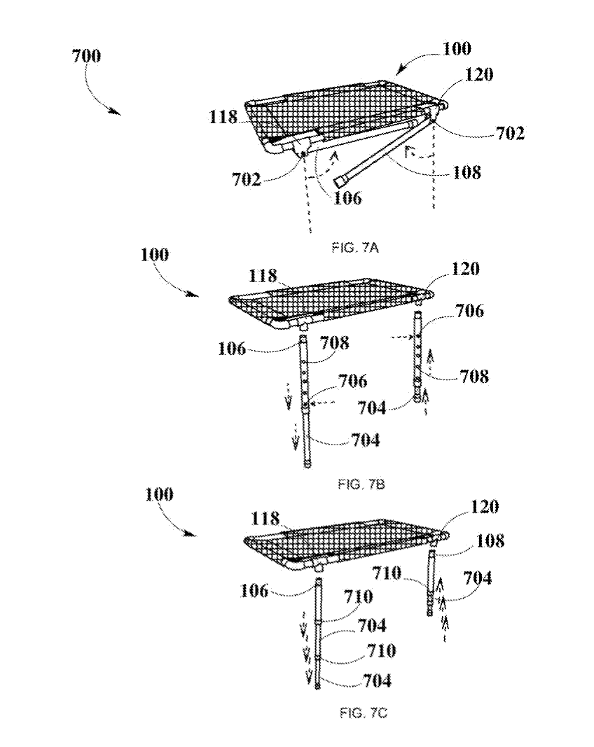

FIGS. 7A-C shows different configurations 700 of support legs 106, 108 that can be used for folding cot apparatus 100 into a fully-folded orientation or for adjusting the height of platform 104 relative to cabin floor 306, according to some embodiments. FIG. 7 A shows a configuration where support legs 106,108 in cot apparatus 100 may be permanently attached to tee connectors 118, 120 through joints 702. These joints 702 may perform a pivotal and lock action for allowing support legs 106,108 to be folded and extended up to a maximum of 90 degrees.

FIG. 7 B and FIG. 7 C show different configurations for adjusting the length of support legs 106, 108. Specifically, length L₂ of support legs 106, 108 in cot apparatus 100 can be adjusted according to the distance between the airplane seat arms 302 and cabin floor 306. In FIG. 7 B, support legs 106, 108 can exhibit a telescopic operation for adjusting length L₂. This telescopic operation can be performed using a leg extension 704 that may include a press member 706, where this press member 706 can be aligned with one or more coupling holes 708 according to the desired length L₂. In another embodiment, FIG. 7 C, telescopic operation can be performed through one or more leg extensions 704 that can be extended and locked at desired length L₂ using screw sockets 710.

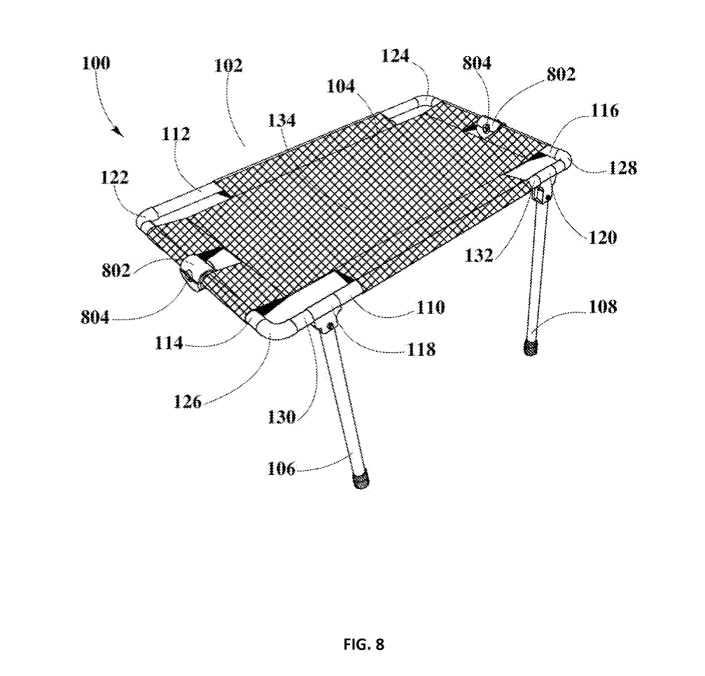

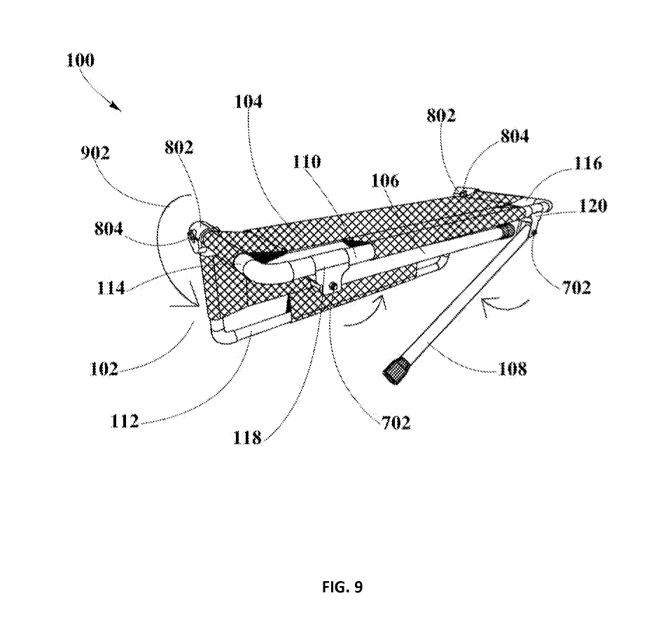

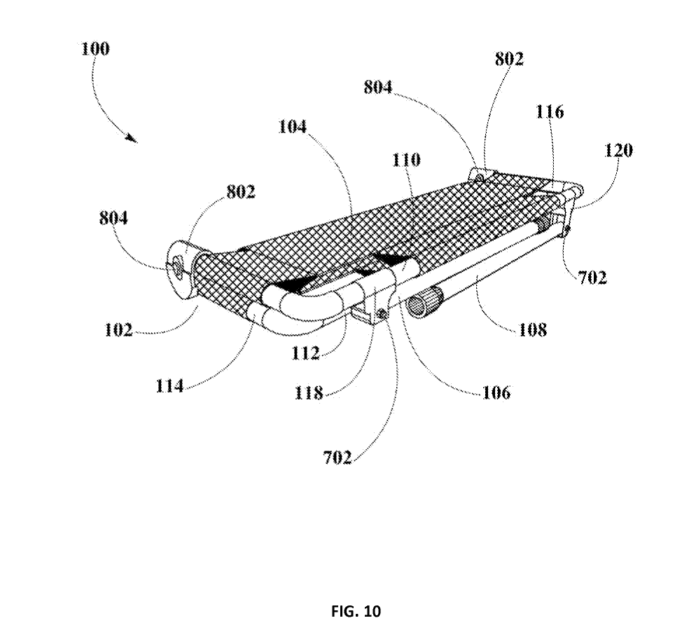

FIG. 8, FIG. 9, and FIG. 10 describe another embodiment where the portable and foldable cot apparatus 100 may exhibit a unibody structure with no detachable components. FIG. 8 shows the unibody configuration of cot apparatus 100 in assembled and in-use orientation that can be implemented in application 300 for assisting a baby's sleep during an airplane flight. According to some aspects of this embodiment, side rails 114, 116 and legs 106, 108 may be permanently attached to frame 102 structure, where side rails 114 and 116 may include a folding mechanism 802 for allowing cot apparatus 100 to be locked in the assembled/in-use orientation. This folding mechanism 802 may include a push button 804 for allowing cot apparatus 100 to be folded or unfolded as required.

FIG. 9 shows the unibody configuration of cot apparatus 100 in pre-folded orientation after being used in application 300. The folding mechanism 802 in frame 102 structure may include a button 804 that can be pressed for folding side rails 114, 116 and platform 104 using a downward action 902, as shown in FIG. 9. Similarly as in FIG. 7 A, legs 106 and 108 may be permanently attached to tee connectors 118, 120 through joints 702. These joints 702 may perform a pivotal and lock action for allowing support legs 106, 108 to be folded and extended up to a maximum of 90 degrees.

FIG. 10 shows the unibody configuration of cot apparatus 100 in a fully-folded orientation. By pressing button 804 in folding mechanism 802, cot apparatus 100 may be collapsed into fully-folded orientation for easy storage and/or carrying. According to some aspects of this embodiment, folding mechanism 802 may maintain cot apparatus 100 in a fully-folded orientation until button 804 is pressed again, in which case, cot apparatus 100 may be unfolded to a pre-folded orientation, and ultimately, to a assembled and in-use orientation. The unibody configuration of cot apparatus 100 may also include a belt, a cord, or Velcro straps for holding cot apparatus 100 in fully-folded orientation.

Other unibody configurations of cot apparatus 100 may include folding mechanism 802 integrated in the front rail 110 and back rail 112 of frame 102 structure, or as required by the application.

While various aspects and embodiments have been disclosed, other aspects and embodiments may be contemplated. The various aspects and embodiments disclosed are for purposes of illustration and are not intended to be limiting, with the true scope and spirit being indicated by the following claims.

1. An apparatus for aiding rest, comprising:
a frame comprising a front rail, a back rail, and at least two side rails;
a platform interconnected with said frame at at least two points; and
at least two supporting legs disposed below the frame and connected thereto;
wherein the platform is suitable for accepting the weight of an infant.

2. The apparatus of claim 1, further comprising a resting region within said platform.

3. The apparatus of claim 1, wherein said platform comprises one selected from the group consisting of canvas, fabric, nylon, and combinations thereof.

4. The apparatus of claim 1, wherein the platform is interconnected with said frame at at least four points.

5. The apparatus of claim 1, wherein the front rail, back rail, and at least two side rails are connected by corner connectors.

6. The apparatus of claim 1, wherein the frame further comprises at least two connectors for modularly accepting the at least two legs.

7. The apparatus of claim 1, wherein the front rail, back rail, and at least two side rails are connected by at least two coupling connectors.

8. The apparatus of claim 1, wherein at least one of the front rail, back rail, and at least two side rails are connected to at least one tee connector.

9. The apparatus of claim 1, wherein the front rail, back rail, and at least two side rails are connected by at least two coupling connectors.

10. The apparatus of claim 1, wherein the at least two supporting legs of are equal height.

11. The apparatus of claim 1, wherein the at least two supporting legs of are adjustable.

12. The apparatus of claim 1, wherein the at least two supporting legs are of a height suitable to allow a portion of the platform to rest on a portion of a stationary object.

13. The apparatus of claim 12, wherein the stationary object is an airline seat.

14. The apparatus of claim 1, wherein the platform is removable.

15. The apparatus of claim 1, wherein the frame comprises one selected from the group consisting of plastic, aluminum, and mixtures thereof.

16. The apparatus of claim 1, wherein one of the at least two support legs comprises one selected from the group consisting of plastic, aluminum, and mixtures thereof.

17. The apparatus of claim 1, wherein the frame and the at least two supporting legs comprise a unibody construction.

18. The apparatus of claim 1, wherein at least one of the front rail, back rail, and at least two side rails comprise at least one folding mechanism.

19. The apparatus of claim 1, wherein the width of the frame is between about 40 cm to about 50 cm.

20. The apparatus of claim 1, wherein the length of the frame is between about 53 cm to about 75 cm.

21. The apparatus of claim 1, wherein height of the supporting legs is between about 50 cm to about 85 cm.

22. The apparatus of claim 1, wherein weight supported by the platform is between about 7 lbs to about 26 lbs.
